(19) United States
(12) Patent Application Publication
(10) Pub. No.: US 2006/0290709 A1
(43) Pub. Date: Dec. 28, 2006

(54) Information processing method and apparatus

(75) Inventors: Hiromi Omi, Tokyo (JP); Makoto Hirota, Tokyo (JP); Kenichirou Nakagawa, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Ohta-ku (JP)

(21) Appl. No.: 10/555,410

(22) PCT Filed: Jun. 1, 2004
(86) PCT No.: PCT/JP04/07905

§ 371 Date: Nov. 3, 2005

(30) Foreign Application Priority Data
Jun. 2, 2003 (JP) 2003-156807

(51) Int. Cl. G09G 5/02

(52) U.S. Cl. 345/594

(57) ABSTRACT

In an information processing method for processing a user's instruction on the basis of a plurality of pieces of input information which are input by a user using a plurality of types of input modalities, each of the plurality of types of input modalities has a description including correspondence between the input contents and semantic attributes. Each input content is acquired by parsing each of the plurality of pieces of input information which are input using the plurality of types of input modalities, and semantic attributes of the acquired input contents are acquired from the description. A multimodal input integration unit integrates the acquired input contents on the basis of the acquired semantic attributes.

### TECHNICAL FIELD

The present invention relates to a so-called multimodal user interface used to issue instructions using a plurality of types of input modalities.

### BACKGROUND ART

A multimodal user interface which allows to input using a desired one of a plurality of types of modalities (input modes) such as a GUI input, speech input, and the like is very convenient for the user. Especially, high convenience is obtained upon making inputs by simultaneously using a plurality of types of modalities. For example, when the user clicks a button indicating an object on a GUI while uttering an instruction word such as “this” or the like, even the user who is not accustomed to a technical language such as commands or the like can freely operate the objective device. In order to attain such operations, a process for integrating inputs by means of a plurality of types of modalities is required.

As examples of the process for integrating inputs by means of a plurality of types of modalities, a method of applying language interpretation to a speech recognition result (Japanese Patent Laid-Open No. 9-114634), a method using context information (Japanese Patent Laid-Open No. 8-234789), a method of combining inputs with approximate input times, and outputting them as a semantic interpretation unit (Japanese Patent Laid-Open No. 8-263258), and a method of making language interpretation and using a semantic structure (Japanese Patent Laid-Open No. 2000-231427) have been proposed.

Also, the IBM et al. have formulated a specification “XHTML+Voice Profile”, and this specification allows to describe a multimodal user interface in a markup language. Details of this specification are described in the W3C Web site (http://www.w3.org/TR/xhtml+voice/). The SALT Forum has published a specification “SALT”, and this specification allows to describe a multimodal user interface in a markup language as in XHTML+Voice Profile above. Details of this specification are described in the SALT Forum Web site (The Speech Application Language Tags: http://www.saltforum.org/).

However, these prior arts require complicated processes such as language interpretation and the like upon integrating a plurality of types of modalities. Even when such complicated process is done, the meaning of inputs that the user intended cannot sometimes be reflected in an application due to an interpretation error and the like of language interpretation. Techniques represented by XHTML+Voice Profile and SALT, and the conventional description method using a markup language have no scheme that handles a description of semantic attributes which represent meanings of inputs.

### DISCLOSURE OF INVENTION

The present invention has been made in consideration of the above situation, and has as its object to implement multimodal input integration that the user intended by a simple process.

More specifically, it is another object of the present invention to implement integration of inputs that the user or designer intended by a simple interpretation process by adopting a new description such as a description of semantic attributes that represent meanings of inputs in a description for processing inputs from a plurality of types of modalities.

It is still another object of the present invention to allow an application developer to describe semantic attributes of inputs using a markup language or the like.

In order to achieve the above objects, according to one aspect of the present invention, there is provided an information processing method for recognizing a user's instruction on the basis of a plurality of pieces of input information which are input by a user using a plurality of types of input modalities, the method having a description including correspondence between input contents and a semantic attribute for each of the plurality of types of input modalities, the method comprising: an acquisition step of acquiring an input content by parsing each of the plurality of pieces of input information which are input using the plurality of types of input modalities, and acquiring semantic attributes of the acquired input contents from the description; and an integration step of integrating the input contents acquired in the acquisition step on the basis of the semantic attributes acquired in the acquisition step.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram showing the basic arrangement of an information processing system according to the first embodiment;

FIG. 2 shows a description example of semantic attributes by a markup language according to the first embodiment;

FIG. 3 shows a description example of semantic attributes by a markup language according to the first embodiment;

FIG. 4 is a flowchart for explaining the flow of the process of a GUI input processor in the information processing system according to the first embodiment;

FIG. 5 is a table showing a description example of grammar (rules of grammar) for speech recognition according to the first embodiment;

FIG. 6 shows a description example of the grammar (rules of grammar) for speech recognition using a markup language according to the first embodiment;

FIG. 7 shows a description example of the speech recognition/interpretation result according to the first embodiment;

FIG. 8 is a flowchart for explaining the flow of the process of a speech recognition/interpretation processor 103 in the information processing system according to the first embodiment;

FIG. 9A is a flowchart for explaining the flow of the process of a multimodal input integration unit 104 in the information processing system according to the first embodiment;

FIG. 9B is a flowchart showing details of step S903 in FIG. 9A;

FIG. 10 shows an example of multimodal input integration according to the first embodiment;

FIG. 11 shows an example of multimodal input integration according to the first embodiment;

FIG. 12 shows an example of multimodal input integration according to the first embodiment;

FIG. 13 shows an example of multimodal input integration according to the first embodiment;

FIG. 14 shows an example of multimodal input integration according to the first embodiment;

FIG. 15 shows an example of multimodal input integration according to the first embodiment;

FIG. 16 shows an example of multimodal input integration according to the first embodiment;

FIG. 17 shows an example of multimodal input integration according to the first embodiment;

FIG. 18 shows an example of multimodal input integration according to the first embodiment;

FIG. 19 shows an example of multimodal input integration according to the first embodiment;

FIG. 20 shows a description example of semantic attributes using a markup language according to the second embodiment;

FIG. 21 shows a description example of grammar (rules of grammar) for speech recognition according to the second embodiment;

FIG. 22 shows a description example of the speech recognition/interpretation result according to the second embodiment;

FIG. 23 shows an example of multimodal input integration according to the second embodiment;

FIG. 24 shows a description example of semantic attributes including “ratio” using a markup language according to the second embodiment;

FIG. 25 shows an example of multimodal input integration according to the second embodiment;

FIG. 26 shows a description example of the grammar (rules of grammar) for speech recognition according to the second embodiment; and

FIG. 27 shows an example of multimodal input integration according to the second embodiment.

### BEST MODE FOR CARRYING OUT THE INVENTION

Preferred embodiments of the present invention will now be described in detail in accordance with the accompanying drawings.

### First Embodiment

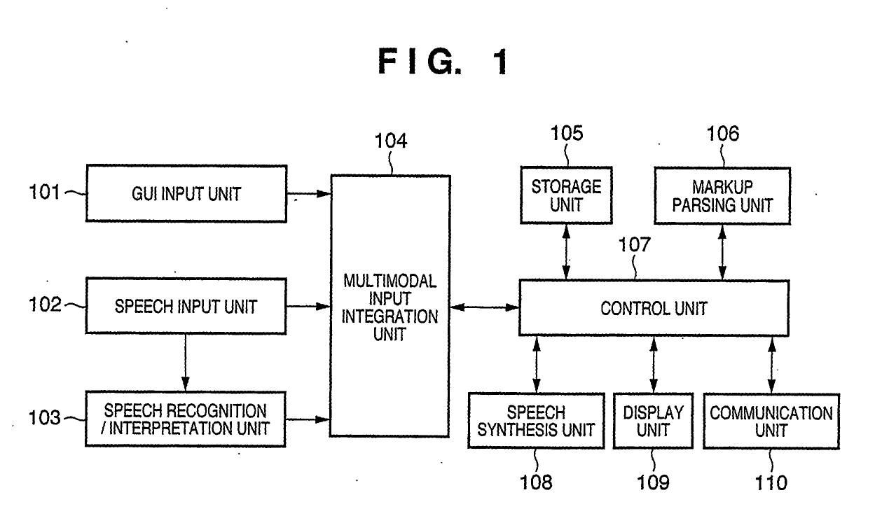

FIG. 1 is a block diagram showing the basic arrangement of an information processing system according to the first embodiment. The information processing system has a GUI input unit 101, speech input unit 102, speech recognition/interpretation unit 103, multimodal input integration unit 104, storage unit 105, markup parsing unit 106, control unit 107, speech synthesis unit 108, display unit 109, and communication unit 110.

The GUI input unit 101 comprises input devices such as a button group, keyboard, mouse, touch panel, pen, tablet, and the like, and serves as an input interface used to input various instructions from the user to this apparatus. The speech input unit 102 comprises a microphone, A/D converter, and the like, and converts user's utterance into a speech signal. The speech recognition/interpretation unit 103 interprets the speech signal provided by the speech input unit 102, and performs speech recognition. Note that a known technique can be used as the speech recognition technique, and a detailed description thereof will be omitted.

The multimodal input integration unit 104 integrates information input from the GUI input unit 101 and speech recognition/interpretation unit 103. The storage unit 105 comprises a hard disk drive device used to save various kinds of information, a storage medium such as a CD-ROM, DVD-ROM, and the like used to provide various kinds of information to the information processing system and a drive, and the like. The hard disk drive device and storage medium store various application programs, user interface control programs, various data required upon executing the programs, and the like, and these programs are loaded onto the system under the control of the control unit 107 (to be described later).

The markup parsing unit 106 parses a document described in a markup language. The control unit 107 comprises a work memory, CPU, MPU, and the like, and executes various processes for the whole system by reading out the programs and data stored in the storage unit 105. For example, the control unit 107 passes the integration result of the multimodal input integration unit 104 to the speech synthesis unit 108 to output it as synthetic speech, or passes the result to the display unit 109 to display it as an image. The speech synthesis unit 108 comprises a loudspeaker, headphone, D/A converter, and the like, and executes a process for generating speech data based on read text, D/A-converts the data into analog data, and externally outputs the analog data as speech. Note that a known technique can be used as the speech synthesis technique, and a detailed description thereof will be omitted. The display unit 109 comprises a display device such as a liquid crystal display or the like, and displays various kinds of information including an image, text, and the like. Note that the display unit 109 may adopt a touch panel type display device. In this case, the display unit 109 also has a function of the GUI input unit (a function of inputting various instructions to this system). The communication unit 110 is a network interface used to make data communications with other apparatuses via networks such as the Internet, LAN, and the like.

Mechanisms (GUI input and speech input) for making inputs to the information processing system with the above arrangement will be described below.

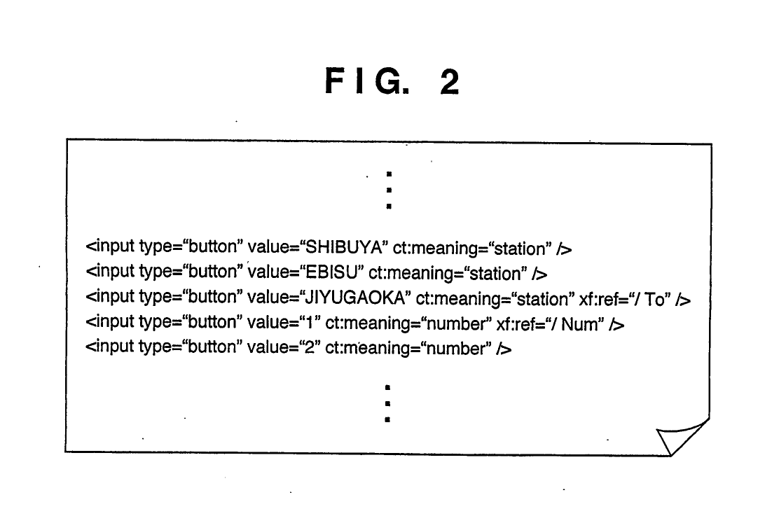

A GUI input will be explained first. FIG. 2 shows a description example using a markup language (XML in this example) used to present respective components. Referring to FIG. 2, an <input> tag describes each GUI component, and a type attribute describes the type of component. A value attribute describes a value of each component, and a ref attribute describes a data model as a bind destination of each component. Such XML document complies with the specification of W3C (World Wide Web Consortium), i.e., it is a known technique. Note that details of the specification are described in the W3C Web site (XHTML: http://www.w3.org/TR/xhtmlll/, XForms: http://www.w3.org/TR/xforms/).

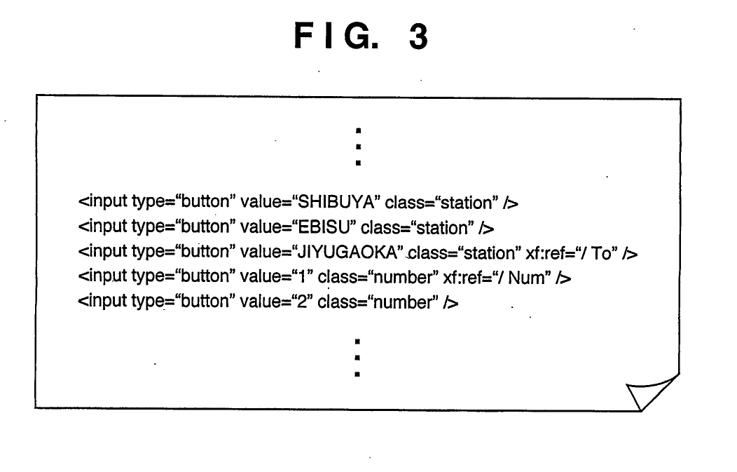

In FIG. 2, a meaning attribute is prepared by expanding the existing specification, and has a structure that can describe a semantic attribute of each component. Since the markup language is allowed to describe semantic attributes of components, an application developer himself or herself can easily set the meaning of each component that he or she intended. For example, in FIG. 2, a meaning attribute “station” is given to “SHIBUYA”, “EBISU”, and “JIYUGAOKA”. Note that the semantic attribute need not always use a unique specification like the meaning attribute. For example, a semantic attribute may be described using an existing specification such as a class attribute in the XHTML specification, as shown in FIG. 3. The XML document described in the markup language is parsed by the markup parsing unit 106 (XML parser).

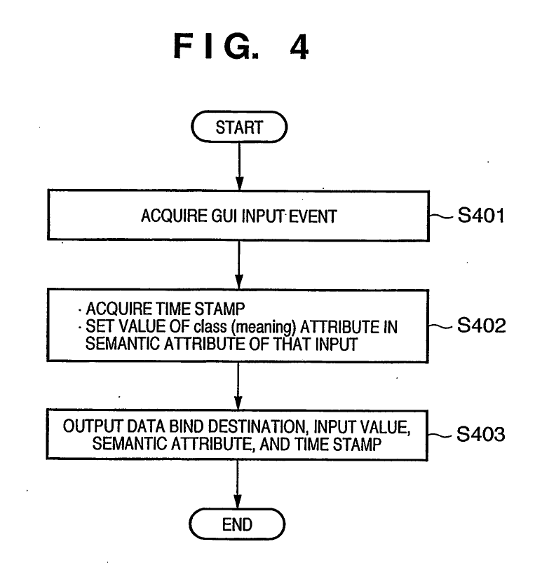

The GUI input processing method will be described using the flowchart of FIG. 4. When the user inputs, e.g., an instruction of a GUI component from the GUI input unit 101, a GUI input event is acquired (step S401). The input time (time stamp) of that instruction is acquired, and the semantic attribute of the 20′ designated GUI component is set to be that of the input with reference to the meaning attribute in FIG. 2 (or the class attribute in FIG. 3) (step S402). Furthermore, the bind destination of data and input value of the designated component are acquired from the aforementioned description of the GUI component. The bind destination, input value, semantic attribute, and time stamp acquired for the data of the component are output to the multimodal input integration unit 104 as input information (step S403).

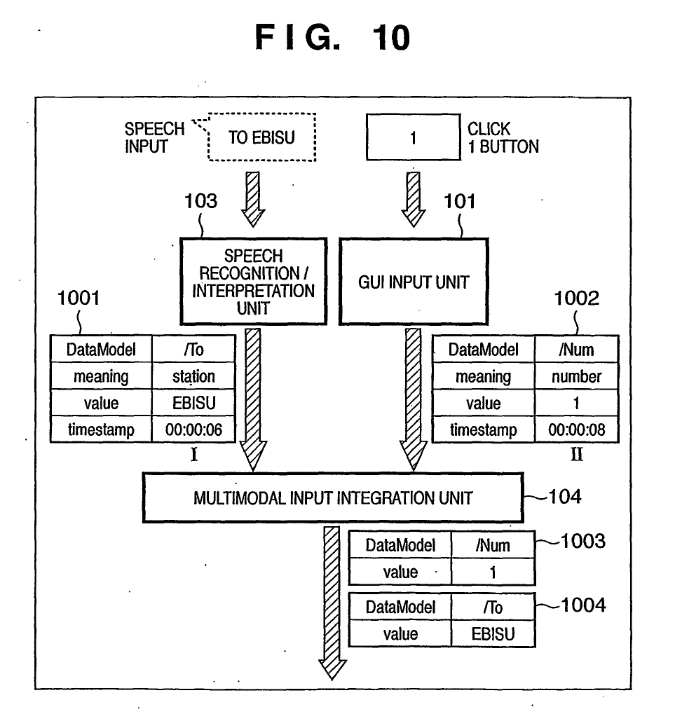

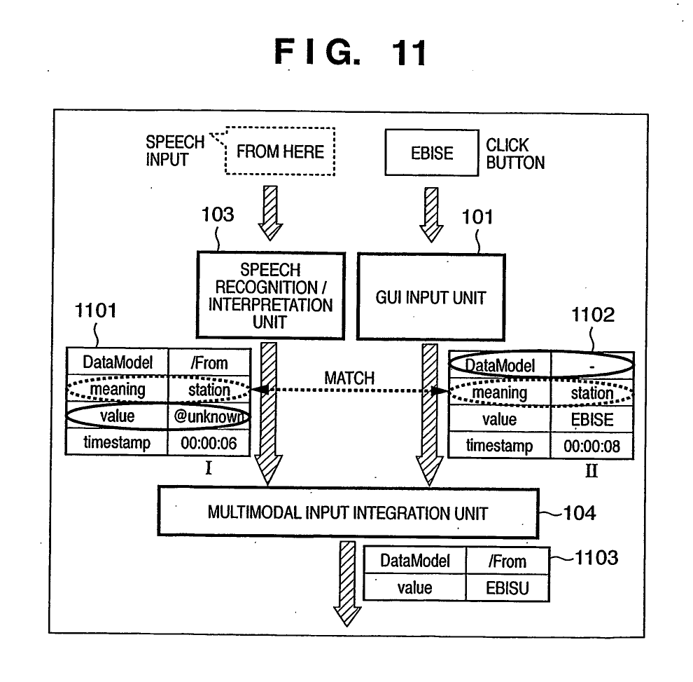

A practical example of the GUI input process will be described below with reference to FIGS. 10 and 11. FIG. 10 shows a process executed when a button with a value “1” is pressed via the GUI. This button is described in the markup language, as shown in FIG. 2 or 3, and it is understood by parsing this markup language that the value is “1”, the semantic attribute is “number”, and the data bind destination is “/Num”. Upon depression of the button “1”, the input time (time stamp; “00:00:08” in FIG. 10) is acquired. Then, the value “1”, semantic attribute “number”, and data bind destination “/Num” of the GUI component, and the time stamp are output to the multimodal input integration unit 104 (FIG. 10: 1002).

Likewise, when a button “EBISU” is pressed, as shown in FIG. 11, a time stamp (“00:00:08” in FIG. 11), a value “EBISU” obtained by parsing the markup language in FIG. 2 or 3, a semantic attribute “station”, and a data bind destination “—(no bind)” is output to the multimodal input integration unit 104 (FIG. 11: 1102). With the above process, the semantic attribute that the application developer intended can be handled as semantic attribute information of the inputs on the application side.

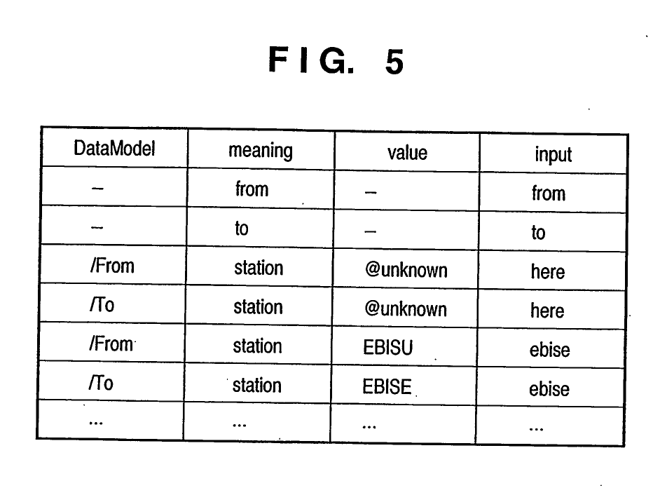

The speech input process from the speech input unit 102 will be described below. FIG. 5 shows grammar (rules of grammar) required to recognize speech. FIG. 5 shows grammar that describes rules for recognizing speech inputs such as “from here”, “to EBISU”, and the like and outputting interpretation results from=“@unknown”, to=“EBISU”, and the like. In FIG. 5, an input string is input speech, and has a structure that describes a value corresponding to the input speech in a value string, a semantic attribute in a meaning string, and a data model of the bind destination in a DataModel string. Since the grammar (rules of grammar) required to recognize speech can describe a semantic attribute (meaning), the application developer himself or herself can easily set the semantic attribute corresponding to each speech input, and the need for complicated processes such as language interpretation and the like can be obviated.

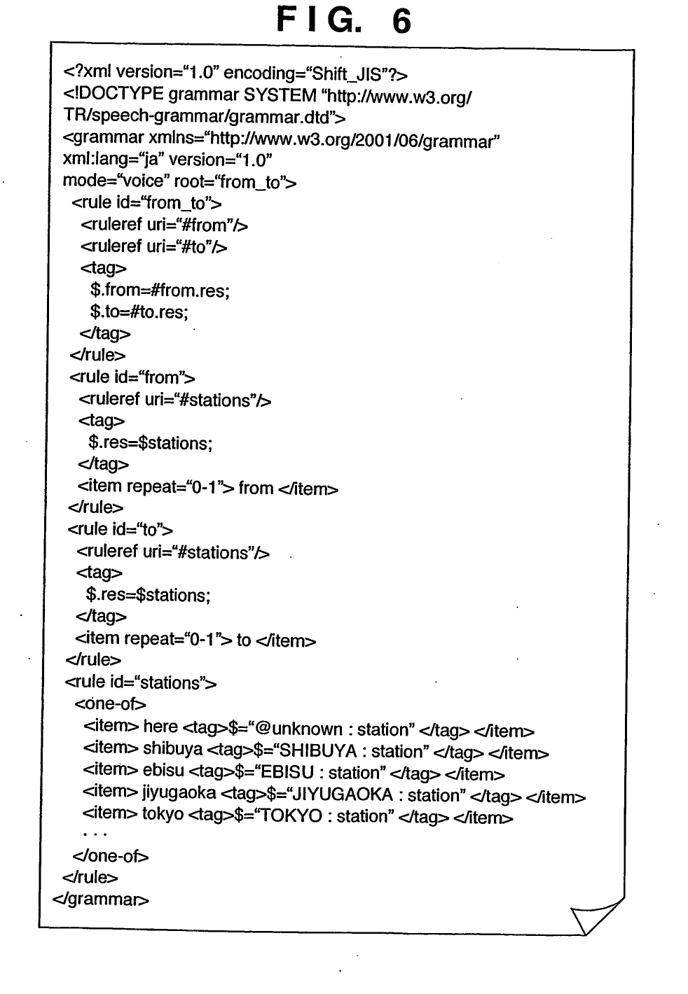

In FIG. 5, the value string describes a special value (@unknown in this example) for an input such as “here” or the like which cannot be processed if it is input alone, and requires correspondence with an input by means of another modality. By specifying this special value, the application side can determine that such input cannot be processed alone, and can skip processes such as language interpretation and the like. Note that the grammar (rules of grammar) may be described using the specification of W3C, as shown in FIG. 6. Details of the specification are described in the W3C Web site (Speech Recognition Grammar Specification: http://www.w3.org/TR/speech-grammar/, Semantic Interpretation for Speech Recognition: http://www.w3.org/TR/semantic-interpretation/). Since the W3C specification does not have a structure that describes the semantic attribute, colon (:) and the semantic attribute are appended to the interpretation result. Hence, a process for separating the interpretation result and semantic attribute is required later. The grammar described in the markup language is parsed by the markup parsing unit 106 (XML parser).

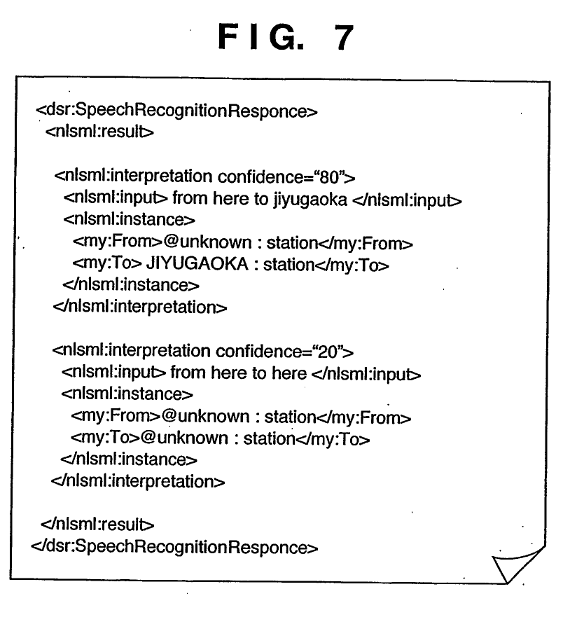

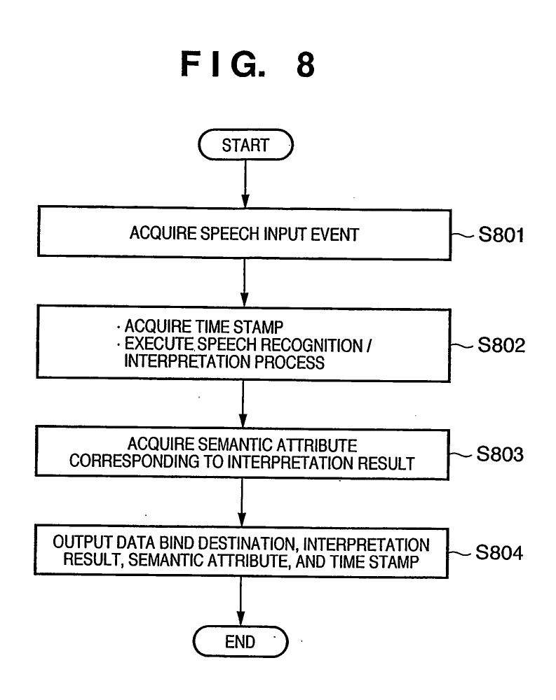

The speech input/interpretation process method will be described below using the flowchart of FIG. 8. When the user inputs speech from the speech input unit 102, a speech input event is acquired (step S801). The input time (time stamp) is acquired, and a speech recognition/interpretation process is executed (step S802). FIG. 7 shows an example of the interpretation process result. For example, when a speech processor connected to a network is used, the interpretation result is obtained as an XML document shown in FIG. 7. In FIG. 7, an <nlsml: interpretation> tag indicates one interpretation result, and a confidence attribute indicates its confidence. Also, an <nlsml: input> tag indicates texts of input speech, and an <nlsml: instance> tag indicates the recognition result. The W3C has published the specification required to express the interpretation result, and details of the specification are described in the W3C Web site (Natural Language Semantics Markup Language for the Speech Interface Framework: http://www.w3.org/TR/nl-spec/). As in the grammar, the speech interpretation result (input speech) can be parsed by the markup parsing unit 106 (XML parser). A semantic attribute corresponding to this interpretation result is acquired from the description of the rules of grammar (step S803). Furthermore, a bind destination and input value corresponding to the interpretation result are acquired from the description of the rules of grammar, and are output to the multimodal input integration unit 104 as input information together with the semantic attribute and time stamp (step S804).

A practical example of the aforementioned speech input process will be described below using FIGS. 10 and 11. FIG. 10 shows a process when speech “to EBISU “is input. As can be seen from the grammar (rules of grammar) in FIG. 6, when speech “to EBISU” is input, the value is “EBISU”, the semantic attribute is “station”, and the data bind destination is “/To”. When speech “to EBISU” is input, its input time (time stamp; “00:00:06” in FIG. 10) is acquired, and is output to the multimodal input integration unit 104 together with the value “EBISU”, semantic attribute “station”, and data bind destination “/To” (FIG. 10: 1001). Note that the grammar (grammar for speech recognition) in FIG. 6 allows a speech input as a combination of one of “here”, “SHIBUYA”, “EBISU”, “JIYUGAOKA”, “TOKYO”, and the like bounded by <one-of> and </one-of> tags, and “from” or “to” (for example, “from here” and “to EBISU”). Also, such combinations can also be combined (for example, “from SHIBUYA to JIYUGAOKA” and “to here, from TOKYO”). A word combined with “from” is interpreted as a from value, a word combined with “to” is interpreted as a to value, and contents bounded by <item>, <tag>, </tag>, and </item> are returned as an interpretation result. Therefore, when speech “to EBISU” is input, “EBISU: station” is returned as a to value, and when speech “from here” is input, “@unknown: station” is returned as a from value. When speech “from EBISU to TOKYO” is input, “EBISU: station” is returned as a from value, and “TOKYO: station” is returned as a to value.

Likewise, when speech “from here” is input, as shown in FIG. 11, a time stamp “00:00:06”, and an input value “@unknown”, semantic attribute “station”, and data bind destination “/From”, which are acquired based on the grammar (rules of grammar) in FIG. 6, are output to the multimodal input integration unit 104 (FIG. 11: 1101). With the above process, in the speech input process, the semantic attribute that the application developer intended can be handled as semantic attribute information of the inputs on the application side.

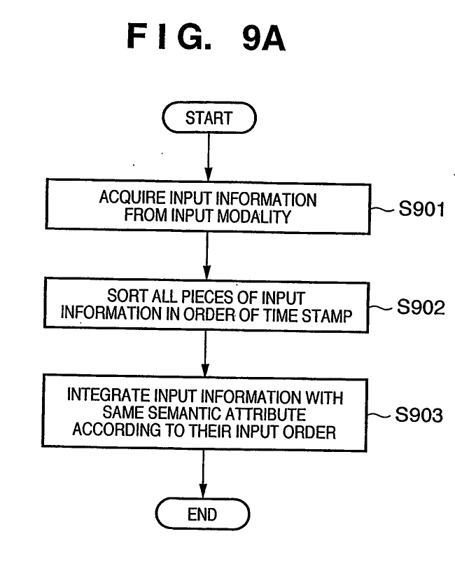

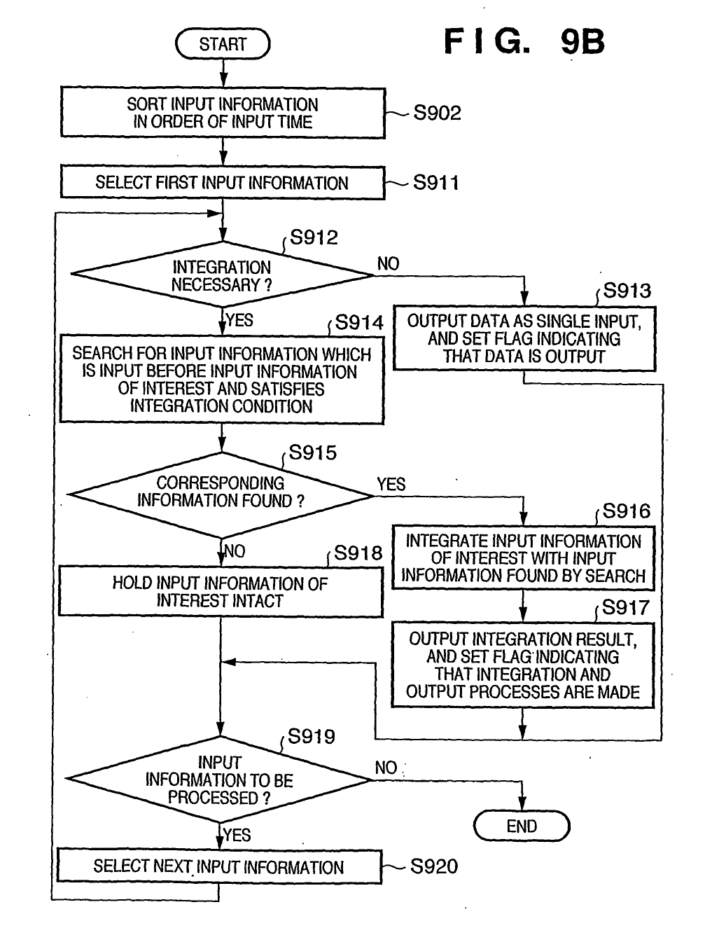

The operation of the multimodal input integration unit 104 will be described below with reference to FIGS. 9A to 19. Note that this embodiment will explain a process for integrating input information (multimodal inputs) from the aforementioned GUI input unit 101 and speech input unit 102.

FIG. 9A is a flowchart showing the process method for integrating input information from the respective input modalities in the multimodal input integration unit 104. When the respective input modalities output a plurality of pieces of input information (data bind destination, input value, semantic attribute, and time stamp), these pieces of input information are acquired (step S901), and all pieces of input information are sorted in the order of time stamps (step S902). Next, a plurality of pieces of input information with the same semantic attribute are integrated in correspondence with their input order (step S903). That is, a plurality of pieces of input information with the same semantic attribute are integrated according to their input order. More specifically, the following process is done. That is, for example, when inputs “from here (click SHIBUYA) to here (click EBISU)” are input, a plurality of pieces of speech input information are input in the order of:

(1) here (station)←“here” of “from here”

(2) here (station)←“here” of “to here”

Also, a plurality of pieces of GUI input (click) information are input in the order of:

(1) SHIBUYA (station)

(2) EBISU (station)

Then, inputs (1) and inputs (2) are respectively integrated.

As conditions required to integrate a plurality of pieces of input information,

(1) the plurality of pieces of information require an integration process;

(2) the plurality of pieces of information are input within a time limit (e.g., the time stamp difference is 3 sec or less);

(3) the plurality of pieces of information have the same semantic attribute;

(4) the plurality of pieces of information do not include any input information having a different semantic attribute when they are sorted in the order of time stamps;

(5) “bind destination” and “value” have a complementary relationship; and

(6) information, which is input earliest, of those which satisfy (1) to (4), is to be integrated. A plurality of pieces of input information which satisfy these integration conditions are to be integrated. Note that the integration conditions are an example, and other conditions may be set. For example, a spatial distance (coordinates) of inputs may be adopted. Note that the coordinates of the TOKYO station, EBISU station, and the like on the map may be used as the coordinates. Also, some of the above integration conditions may be used as the integration conditions (for example, only conditions (1) and (3) are used as the integration conditions). In this embodiment, inputs of different modalities are integrated, but inputs of an identical modality are not integrated.

Note that condition (4) is not always necessary. However, by adding this condition, the following advantages are expected.

For example, when speech “from here, two tickets, to here” is input, if it is considered as click timings and integration interpretations that

(a) “(click) from here, two tickets, to here”→it is natural to integrate click and “here (from)”;

(b) “from (click) here, two tickets, to here”→it is natural to integrate click and “here (from)”;

(c) “from here (click), two tickets, to here”→it is natural to integrate click and “here (from)”;

(d) “from here, two (click) tickets, to here”→it is hard to say even for humans whether click is to be integrated with “here (from)” or “here (to)”; and

(e) “from here, two tickets, (click) to here”→it is natural to integrate click and “here (to)”, when condition (4) is not used, i.e., when a different semantic attribute can be included, click and “here (from)” are integrated in (e) above if they have close timings. However, it is obvious for those who are skilled in the art that such conditions may change depending on the use purposes of an interface.

FIG. 9B is a flowchart for explaining the integration process in step S903 in more detail. After a plurality of pieces of input information are sorted in the chronological order in step S902, the first input information is selected in step S911. It is checked in step S912 if the selected input information requires integration. In this case, if at least one of the bind destination and input value of the input information is not settled, it is determined that integration is required; if both the bind destination and input values are settled, it is determined that integration is not required. If it is determined that integration is not required, the flow advances to step S913, and the multimodal input integration unit 104 outputs the bind destination and input value of that input information as a single input. At the same time, a flag indicating that the input information is output is set. The flow then jumps to step S919.

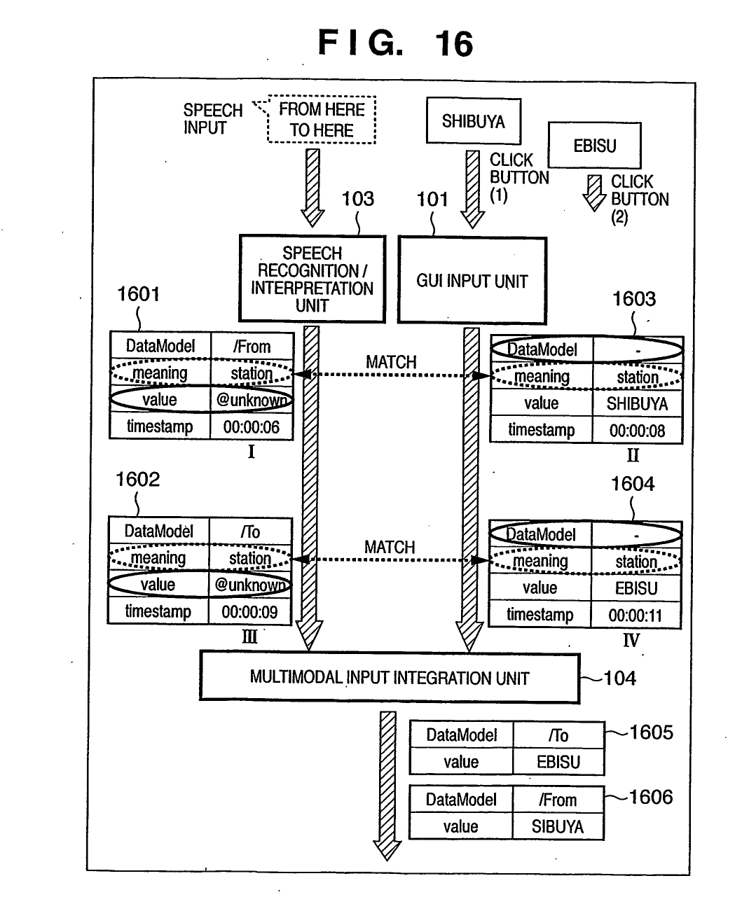

On the other hand, if it is determined that integration is required, the flow advances to step S914 to search for input information, which is input before the input information of interest, and satisfies the integration conditions. If such input information is found, the flow advances from step S915 to step S916 to integrate the input information of interest with the found input information. This integration process will be described later using FIGS. 16 to 19. The flow advances to step S917 to output the integration result, and to set a flag indicating that the two pieces of input information are integrated. The flow then advances to step S919.

If the search process cannot find any input information that can be integrated, the flow advances to step S918 to hold the selected input information intact. The next input information is selected (steps S919 and S920, and the aforementioned processes are repeated from step S912. If it is determined in step S919 that no input information to be processed remains, this process ends.

Examples of the multimodal input integration process will be described in detail below with reference to FIGS. 10 to 19. In the description of each process, the step numbers in FIG. 9B are described in parentheses. Also, the GUI inputs and grammar for speech recognition are defined, as shown in FIG. 2 or 3, and FIG. 6.

An example of FIG. 10 will be explained. As described above, speech input information 1001 and GUI input information 1002 are sorted in the order of time stamps, and are processed in turn from input information with an earlier time stamp (in FIG. 10, circled numbers indicate the order). In the speech input information 1001, all the data bind destination, semantic attribute, and value are settled. For this reason, the multimodal input integration unit 104 outputs the data bind destination “/To” and value “EBISU” as a single input (FIG. 10: 1004, S912, S913 in FIG. 9B). Likewise, since all the data bind destination, semantic attribute, and value are settled in the GUI input information 1002, the multimodal input integration unit 104 outputs the data bind destination “/Num” and value “1” as a single input (FIG. 10: 1003).

An example of FIG. 11 will be described below. Since speech input information 1101 and GUI input information 1102 are sorted in the order of time stamps, and are processed in turn from input information with an earlier time stamp, the speech input information 1101 is processed first. The speech input information 1101 cannot be processed as a single input and requires an integration process, since its value is “@unknown”. As information to be integrated, GUI input information input before the speech input information 1101 is searched for an input that similarly requires an integration process (in this case, information whose bind destination is not settled). In this case, since there is no input before the speech input information 1101, the process of the next GUI input information 1102 starts while holding the information. The GUI input information 1102 cannot be processed as a single input and requires an integration process (S912), since its data model is “—(no bind)”.

In case of FIG. 11, since input information that satisfies the integration conditions is the speech input information 1101, the GUI input information 1102 and speech input information 1101 are selected as information to be integrated (S915). The two pieces of information are integrated, and the data bind destination “/From” and value “EBISU” are output (FIG. 11: 1103) (S916).

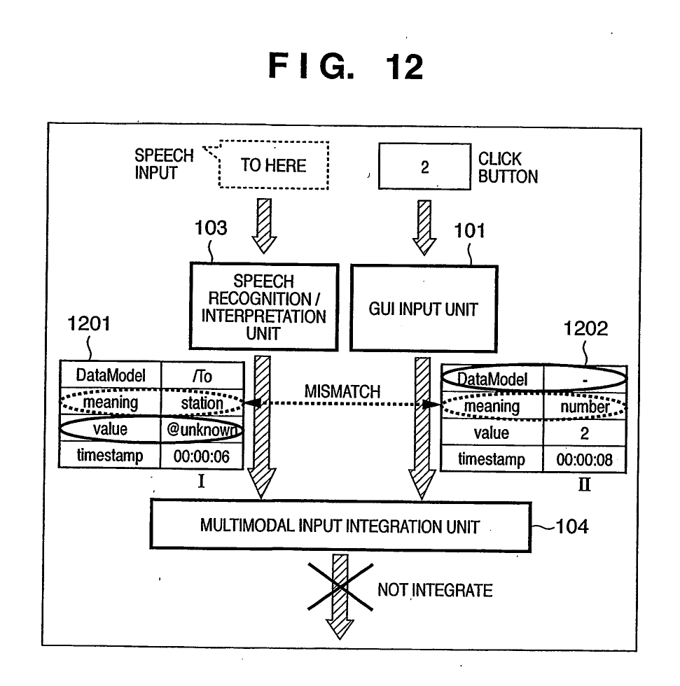

An example of FIG. 12 will be described below. Speech input information 1201 and GUI input information 1202 are sorted in the order of time stamps, and are processed in turn from input information with an earlier time stamp. The speech input information 1201 cannot be processed as a single input and requires an integration process, since its value is “@unknown”. As information to be integrated, GUI input information input before the speech input information 1201 is searched for an input that similarly requires an integration process. In this case, since there is no input before the speech input information 1201, the process of the next GUI input information 1202 starts while holding the information. The GUI input information 1202 cannot be processed as a single input and requires an integration process, since its data model is “—(no bind)”. As information to be integrated, speech input information input before the GUI input information 1202 is searched for input information that satisfies the integration condition (S912, S914). In this case, the speech input information 1201 input before the GUI input information 1202 has a different semantic attribute from that of the information 1202, and does not satisfy the integration condition. Therefore, the integration process is skipped, and the next process starts while holding the information as in the speech input information 1201 (S914, S915-S918).

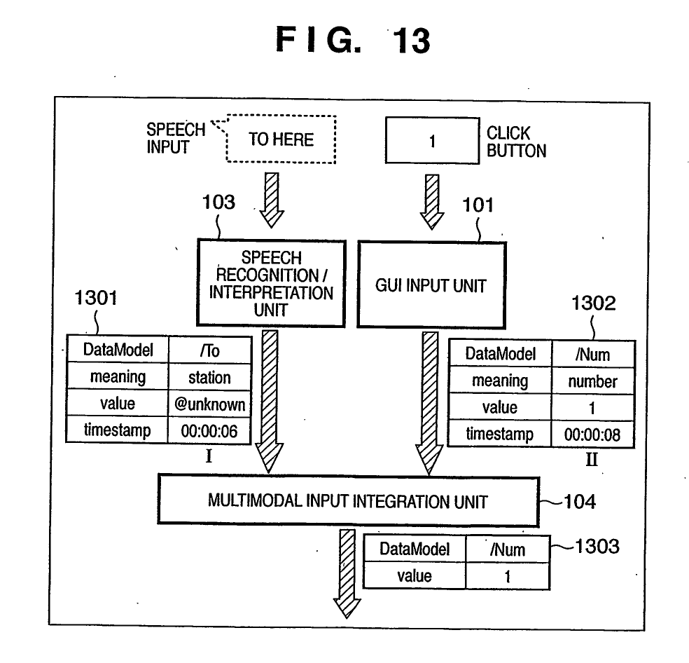

An example of FIG. 13 will be described below. Speech input information 1301 and GUI input information 1302 are sorted in the order of time stamps, and are processed in turn from input information with an earlier time stamp. The speech input information 1301 cannot be processed as a single input and requires an integration process (S912), since its value is “@unknown”. As information to be integrated, GUI input information input before the speech input information 1301 is searched for an input that similarly requires an integration process (S914). In this case, since there is no input before the speech input information 1301, the process of the next GUI input information 1302 starts while holding the information. Since all the data bind destination, semantic attribute, and value are settled in the GUI input information 1302, the data bind destination “/Num” and value “1” are output as a single input (FIG. 13: 1303) (S912, S913). Hence, the speech input information 1301 is kept held.

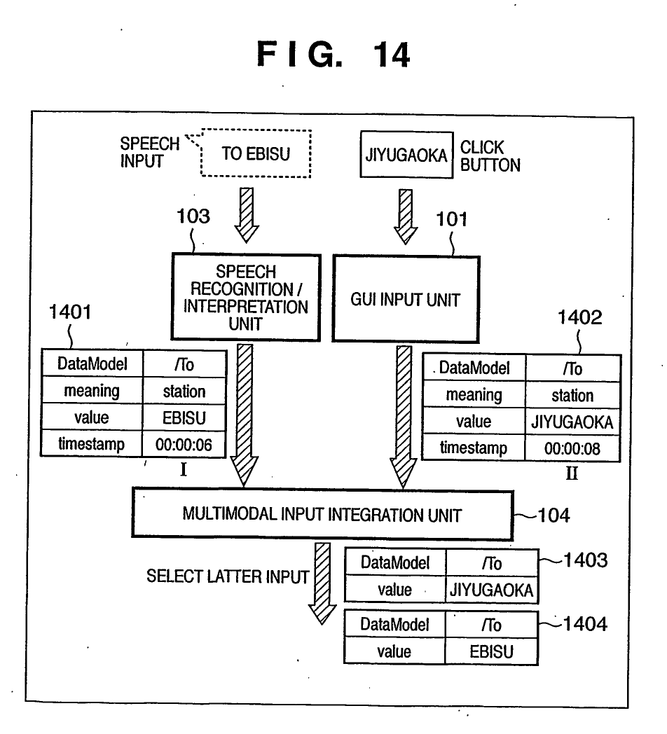

An example of FIG. 14 will be described below. Speech input information 1401 and GUI input information 1402 are sorted in the order of time stamps, and are processed in turn from input information with an earlier time stamp. Since all the data bind destination (/To), semantic attribute, and value are settled in the speech input information 1401, the data bind destination “/To” and value “EBISU” are output as a single input (FIG. 14: 1404) (S912, S913). Next, in the GUI input information 1402 as well, the data bind destination “/To” and value “JIYUGAOKA” are output as a single input (FIG. 14: 1403) (S912, S913). As a result, since 1403 and 1404 have the same data bind destination “/To”, the value “JIYUGAOKA” of 1403 is overwritten on the value “EBISU” of 1404. That is, the contents of 1404 are output, and those of 1403 are then output. Such state is normally considered as “contention of information” since “EBISU” is received as one input and “JIYUGAOKA” is received as the other input, although identical data are to be input in the same time band. In this case, which of information is to be selected is a problem. A method of processing information after a chronologically close input is waited may be used. However, much time is required with this method until the processing result is obtained. Hence, this embodiment executes a process for outputting data in turn without waiting for such input.

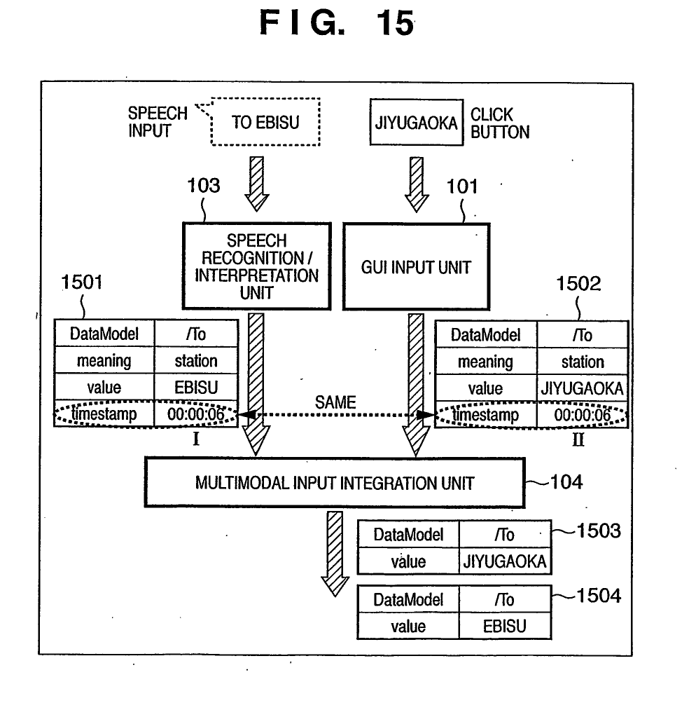

An example of FIG. 15 will be described below. Speech input information 1501 and GUI input information 1502 are sorted in the order of time stamps, and are processed in turn from input information with an earlier time stamp. In this case, since the two pieces of input information have the same time stamp, the processes are done in the order of a speech modality and GUI modality. As for this order, these pieces of information may be processed in the order that they arrive the multimodal input integration unit, or in the order of input modalities set in advance in a browser. As a result, since all the data bind destination, semantic attribute, and value of the speech input information 1501 are settled, the data bind destination “/To” and value “EBISU” are output as a single input (FIG. 15: 1504). Next, when the GUI input information 1502 is processed, the data bind destination “/To” and value “JIYUGAOKA” are output as a single input (FIG. 15: 1503). As a result, since 1503 and 1504 have the same data bind destination “/To”, the value “JIYUGAOKA” of 1503 is overwritten on the value “EBISU” of 1504.

An example of FIG. 16 will be described below. Speech input information 1601, speech input information 1602, GUI input information 1603, and GUI input information 1604 are sorted in the order of time stamps, and are processed in turn from input information with an earlier time stamp (indicated by circled numbers 1 to 4 in FIG. 16). The speech input information 1601 cannot be processed as a single input and requires an integration process (S912), since its value is “@unknown”. As information to be integrated, GUI input information input before the speech input information 1601 is searched for an input that similarly requires an integration process (S914). In this case, since there is no input before the speech input information 1601, the process of the next GUI input information 1602 starts while holding the information (S915, S918-S920). The GUI input information 1603 cannot be processed as a single input and requires an integration process (S912), since its data model is “—(no bind)”. As information to be integrated, speech input information input before the GUI input information 1603 is searched for input information that satisfies the integration condition (S914). In case of FIG. 16, since the speech input information 1601 and GUI input information 1603 satisfy the integration conditions, the GUI information 1603 and speech input information 1601 are integrated (S916). After these two pieces of information are integrated, the data bind destination “/From” and value “SHIBUYA” are output (FIG. 16: 1606) (S917), and the process of the speech input information 1602 as the next information starts (S920). The speech input information 1602 cannot be processed as a single input and requires an integration process (S912), since its value is “@unknown”. As information to be integrated, GUI input information input before the speech input information 1602 is searched for an input that similarly requires an integration process (S914). In this case, the GUI input information 1603 has already been processed, and there is no GUT input information that requires an integration process before the speech input information 1602. Hence, the process of the next GUI information 1604 starts while holding the speech input information 1602 (S915, S918-S920). The GUI input information 1604 cannot be processed as a single input and requires an integration process, since its data model is “—(no bind)” (S912). As information to be integrated, speech input information input before the GUI input information 1604 is searched for input information that satisfies the integration condition (S914). In this case, since input information that satisfies the integration condition is the speech input information 1602, the GUI input information 1604 and speech input information 1602 are integrated. These two pieces of information are integrated, and the data bind destination “/To” and value “EBISU” are output (FIG. 16: 1605) (S915-S917).

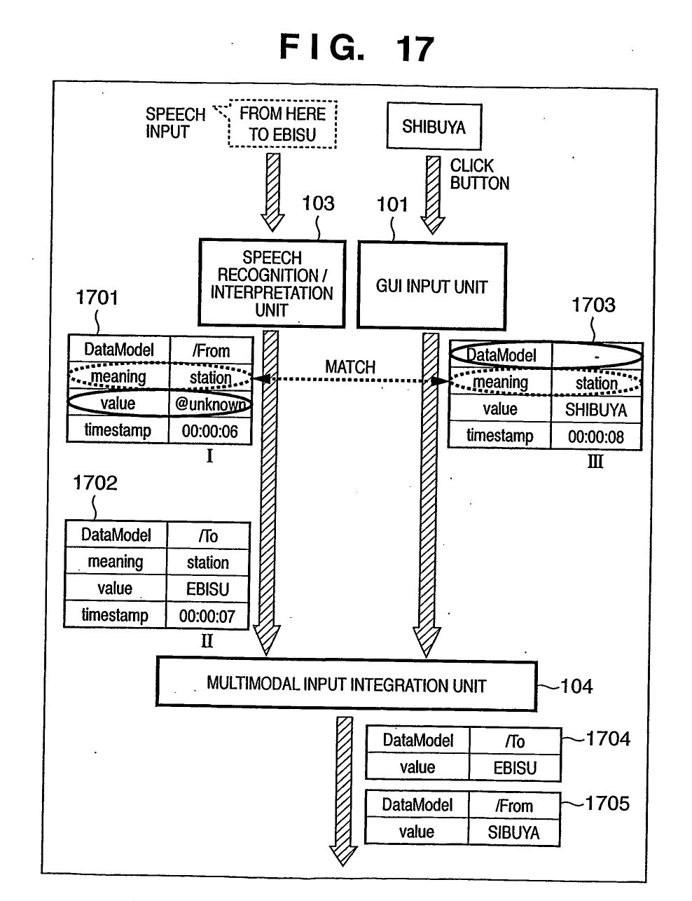

An example of FIG. 17 will be described below. Speech input information 1701, speech input information 1702, and GUI input information 1703 are sorted in the order of time stamps, and are processed in turn from input information with an earlier time stamp. The speech input information 1701 as the first input information cannot be processed as a single input and requires an integration process, since its value is “@unknown”. As information to be integrated, GUI input information input before the speech input information 1701 is searched for an input that similarly requires an integration process (S912, S914). In this case, since there is no input before the speech input information 1701, the process of the next speech input information 1702 starts while holding this information (S915, S918-S920). Since all the data bind destination, semantic attribute, and value of the speech input information 1702 are settled, the data bind destination “/To” and value “EBISU” are output as a single input (FIG. 17: 1704) (S912, S913).

Subsequently, the process of the GUI input information 1703 as the next input information starts. The GUI input information 1703 cannot be processed as a single input and requires an integration process, since its data model is “—(no bind)”. As information to be integrated, speech input information input before the GUI input information 1703 is searched for input information that satisfies the integration condition. As input information that satisfies the integration condition, the speech input information 1701 is found. Hence, the GUI input information 1703 and speech input information 1701 are integrated and, as a result, the data bind destination”/From” and value “SHIBUYA” are output (FIG. 17: 1705) (S915-S917).

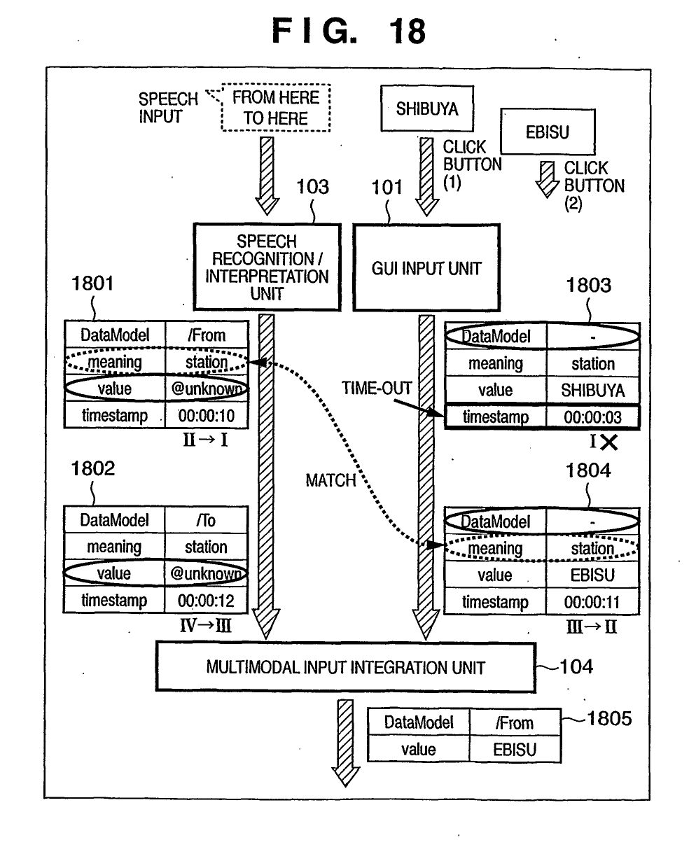

An example of FIG. 18 will be described below. Speech input information 1801, speech input information 1802, GUI input information 1803, and GUI input information 1804 are sorted in the order of time stamps, and are processed in turn from input information with an earlier time stamp. In case of FIG. 18, these pieces of input information are processed in the order of 1803, 1801, 1804, and 1802.

The first GUI input information 1803 cannot be processed as a single input and requires an integration process, since its data model is “—(no bind)”. As information to be integrated, speech input information input before the GUI input information 1803 is searched for input information that satisfies the integration condition. In this case, since there is no input before the GUI input information 1803, the process of the speech input information 1801 as the next input information starts while holding the information (S912, S914, S915). The speech input information 1801 cannot be processed as a single input and requires an integration process, since its value is “@unknown”. As information to be integrated, GUI input information input before the speech input information 1801 is searched for an input that similarly requires an integration process (S912, S914). In this case, the GUI input information 1803 input before the speech input information 1801 is present, but it reaches a time-out (the time stamp difference is 3 sec or more) and does not satisfy the integration conditions. Hence, the integration process is not executed. As a result, the process of the next GUI information 1804 starts while holding the speech input information 1801 (S915, S918-S920).

The GUI input information 1804 cannot be processed as a single input and requires an integration process, since its data model is “—(no bind)”. As information to be integrated, speech input information input before the GUI input information 1804 is searched for input information that satisfies the integration condition (S912, S914). In case of FIG. 18, since the speech input information 1801 satisfies the integration conditions, the GUI information 1804 and speech input information 1801 are integrated. After these two pieces of information are integrated, the data bind destination “/From” and value “EBISU” are output (FIG. 18: 1805) (S915-S917).

After that, the process of the speech input information 1802 starts. The speech input information 1802 cannot be processed as a single input and requires an integration process, since its value is “@unknown”. As information to be integrated, GUI input information input before the speech input information 1802 is searched for an input that similarly requires an integration process (S912, S914). In this case, since there is no input before the speech input information 1802, the next process starts while holding the information (S915, S918-S920).

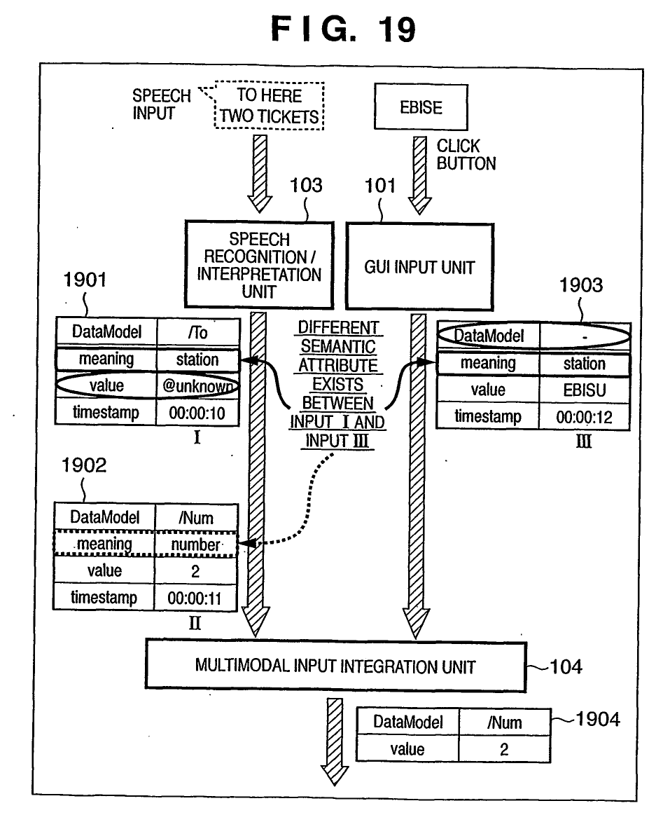

An example of FIG. 19 will be described below. Speech input information 1901, speech input information 1902, and GUI input information 1903 are sorted in the order of time stamps, and are processed in turn from input information with an earlier time stamp. In case of FIG. 19, these pieces of input information are sorted in the order of 1901, 1902, and 1903.

The speech input information 1901 cannot be processed as a single input and requires an integration process, since its value is “@unknown”. As information to be integrated, GUI input information input before the speech input information 1901 is searched for an input that similarly requires an integration process (S912, S914). In this case, since there is no GUI input information input before the speech input information 1901, the integration process is skipped, and the process of the next speech input information 1902 starts while holding information (S915, S918-S920). Since all the data bind destination, semantic attribute, and value of the speech input information 1902 are settled, the data bind destination “/Num” and value “2” are output as a single input (FIG. 19: 1904) (S912, S913). Next, the process of the GUI input information 1903 starts (S920). The GUI input information 1903 cannot be processed as a single input and requires an integration process, since its data model is “—(no bind)”. As information to be integrated, speech input information input before the GUI input information 1903 is searched for input information that satisfies the integration condition (S912, S914). In this case, the speech input information 1901 does not satisfy the integration conditions, since the input information 1902 with a different semantic attribute is present between them. Hence, the integration process is skipped, and the next process starts while holding the information (S915, S918-S920).

As described above, since the integration process is executed based on the time stamps and semantic attributes, a plurality of pieces of input information from respective input modalities can be normally integrated. As a result, when the application developer sets a common semantic attribute in inputs to be integrated, his or her intention can be reflected on the application.

As described above, according to the first embodiment, an XML document and grammar (rules of grammar) for speech recognition can describe a semantic attribute, and the intention of the application developer can be reflected on the system. When the system that comprises the multimodal user interface exploits the semantic attribute information, multimodal inputs can be efficiently integrated.

### Second Embodiment

The second embodiment of an information processing system according to the present invention will be described below. In the example of the aforementioned first embodiment, one semantic attribute is designated for one input information (GUI component or input speech). The second embodiment will exemplify a case wherein a plurality of semantic attributes can be designated for one input information.

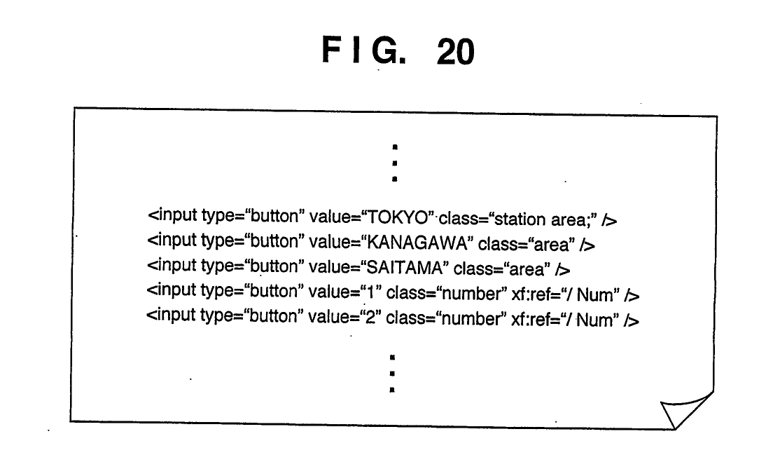

FIG. 20 shows an example of an XHTML document used to present respective GUI components in the 5 information processing system according to the second embodiment. In FIG. 20, an <input> tag, type attribute, value attribute, ref attribute, and class attribute are described by the same description method as that of FIG. 3 in the first embodiment. However, unlike in the first embodiment, the class attribute describes a plurality of semantic attributes. For example, a button having a value “TOKYO” describes “station area” in its class attribute. The markup parsing unit 106 parses this class attribute as two semantic attributes “station” and “area” which have a white space character as a delimiter. More specifically, a plurality of semantic attributes can be described by delimiting them using a space.

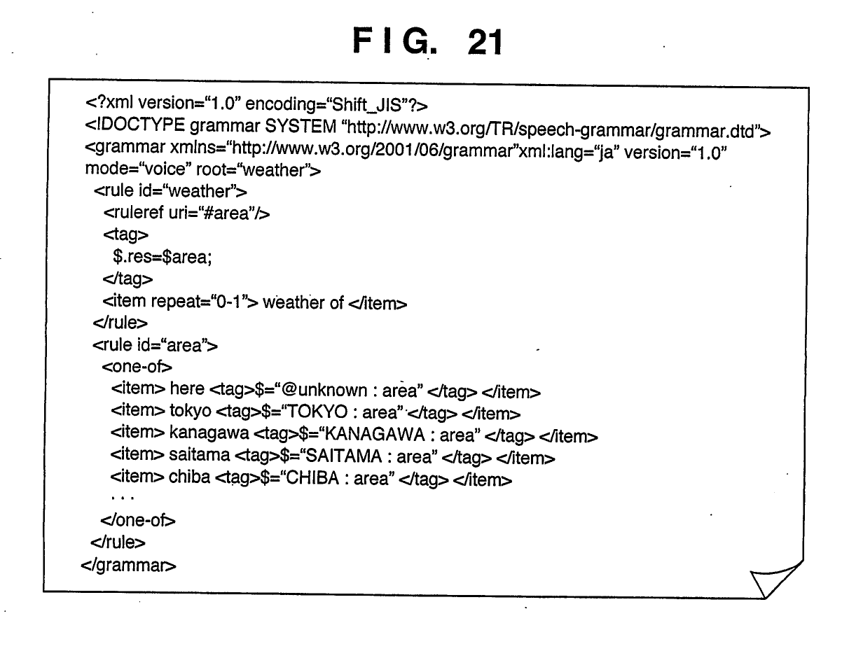

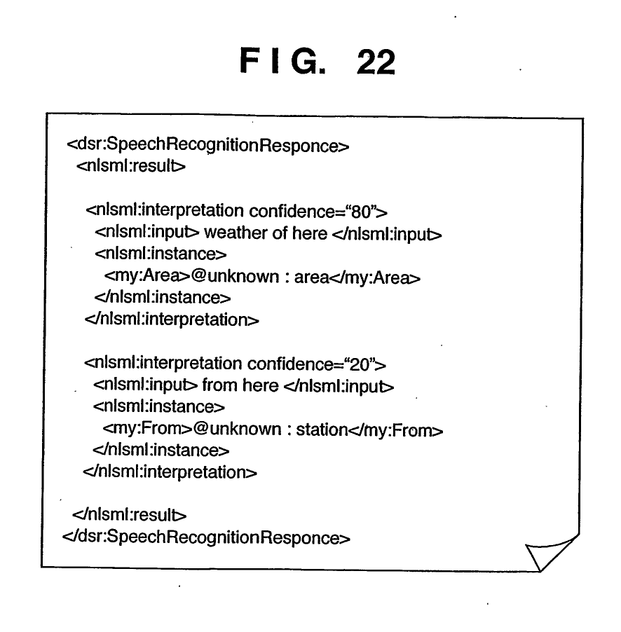

FIG. 21 shows grammar (rules of grammar) required to recognize speech. The grammar in FIG. 21 is described by the same description method as that in FIG. 7, and describes rules required for recognizing speech inputs “weather of here”, “weather of TOKYO”, and the like, and outputting an interpretation result such as area=“@unknown”. FIG. 22 shows an example of the interpretation result obtained when both the grammar (rules of grammar) shown in FIG. 21 and that shown in FIG. 7 are used. For example, when a speech processor connected to a network is used, the interpretation result is obtained as an XML document shown in FIG. 22. FIG. 22 is described by the same description method as that in FIG. 7. According to FIG. 22, the confidence level of “weather of here” is 80, and that of “from here” is 20.

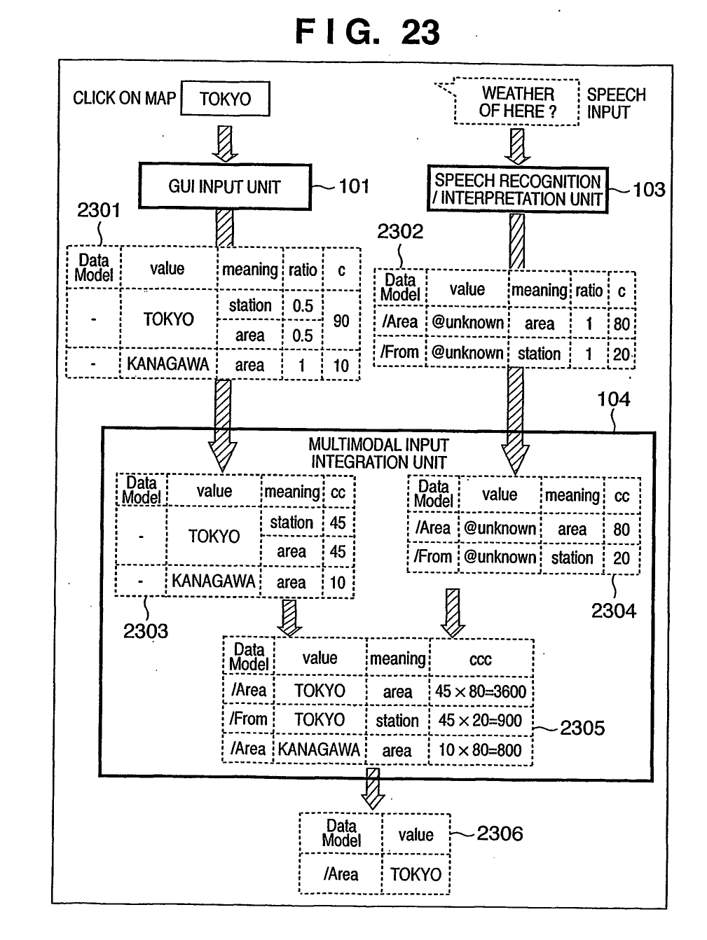

The processing method upon integrating a plurality of pieces of input information each having a plurality of semantic attributes will be described below taking FIG. 23 as an example. In FIG. 23, “DataModel” of GUI input information 2301 is a data bind destination, “value” is a value, “meaning” is a semantic attribute, “ratio” is the confidence level of each semantic attribute, and “c” is the confidence level of the value. These “DataModel”, “value”, “meaning”, and “ratio” are obtained by parsing the XML document shown in FIG. 20 by the markup parsing unit 106. Note that “ratio” of these data assumes a value obtained by dividing 1 by the number of semantic attributes if it is not specified in the meaning attribute (or class attribute) (hence, for TOKYO, “ratio” of each of station and area is 0.5). Also, “c” is the confidence level of the value, and this value is calculated by the application when the value is input. For example, in case of the GUI input information 2301, “c” is the confidence level when a point at which the probability that the value is TOKYO is 90% and the probability that the value is KANAGAWA is 10% is designated (for example, when a point on a map is designated by drawing a circle with a pen, and that circle includes TOKYO 90% and KANAGAWA 10%).

Also, in FIG. 23, “c” of speech input information 2302 is the confidence level of a value, which uses a normalization likelihood (recognition score) for each recognition candidate. The speech input information 2302 is an example when the normalization likelihood (recognition score) of “weather of here” is 80 and that of “from here” is 20. FIG. 23 does not describe any time stamp, but the time stamp information is utilized as in the first embodiment.

The integration conditions according to the second embodiment include:

(1) the plurality of pieces of information require an integration process;

(2) the plurality of pieces of information are input within a time limit (e.g., the time stamp difference is 3 sec or less);

(3) at least one of semantic attributes of information matches that of information to be integrated;

(4) the plurality of pieces of information do not include any input information having semantic attributes, none of which match, when they are sorted in the order of time stamps;

(5) “bind destination” and “value” have a complementary relationship; and

(6) information, which is input earliest, of those which satisfy (1) to (4), is to be integrated. Note that the integration conditions are an example, and other conditions may be set. Also, some of the above integration conditions may be used as the integration conditions (for example, only conditions (1) and (3) are used as the integration conditions). In this embodiment as well, inputs of different modalities are integrated, but inputs of an identical modality are not integrated.

The integration process of the second embodiment will be described below using FIG. 23. The GUI input information 2301 is converted into GUI input information 2303 to have a confidence level “cc” obtained by multiplying the confidence level “c” of the value and the confidence level “ratio” of the semantic attribute in FIG. 23. Likewise, the speech information 2302 is converted into speech input information 2304 to have a confidence level “cc” obtained by multiplying the confidence level “c” of the value and the confidence level “ratio” of the semantic attribute in FIG. 23 (in FIG. 23, the confidence level of the semantic attribute is “1” since each speech recognition result has only one semantic attribute; for example, when a speech recognition result “TOKYO” is obtained, it includes semantic attributes “station” and “area”, and their confidence levels are 0.5). The integration method of respective pieces of speech input information is the same as that in the first embodiment. However, since one input information includes a plurality of semantic attributes and a plurality of values, a plurality of integration candidates are likely to appear in step S916, as indicated by 2305 in FIG. 23.

Next, a value obtained by multiplying the confidence levels of matched semantic attributes is set as a confidence level “ccc” in the GUI input information 2303 and speech input information 2304 to generate a plurality of pieces of input information 2305. Of the plurality of pieces of input information 2305, input information with the highest confidence level (ccc) is selected, and a bind destination “/Area” and value “TOKYO” of the selected data (data of ccc=3600 in this example) are output (FIG. 23: 2306). If a plurality of pieces of information have the same confidence level, information which is processed first is preferentially selected.

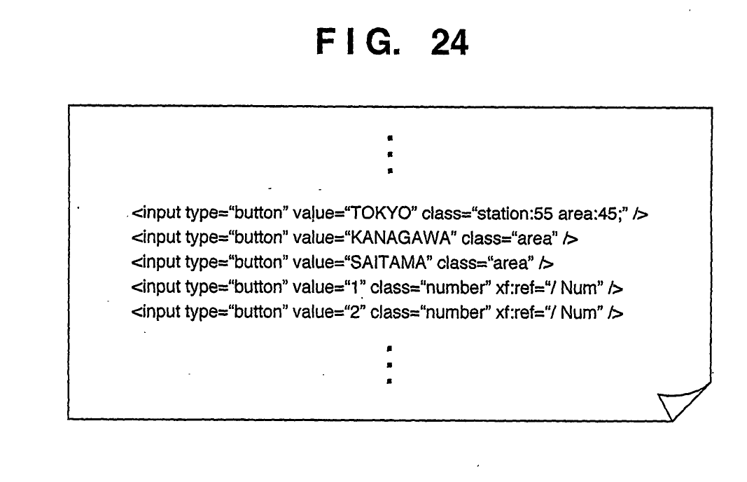

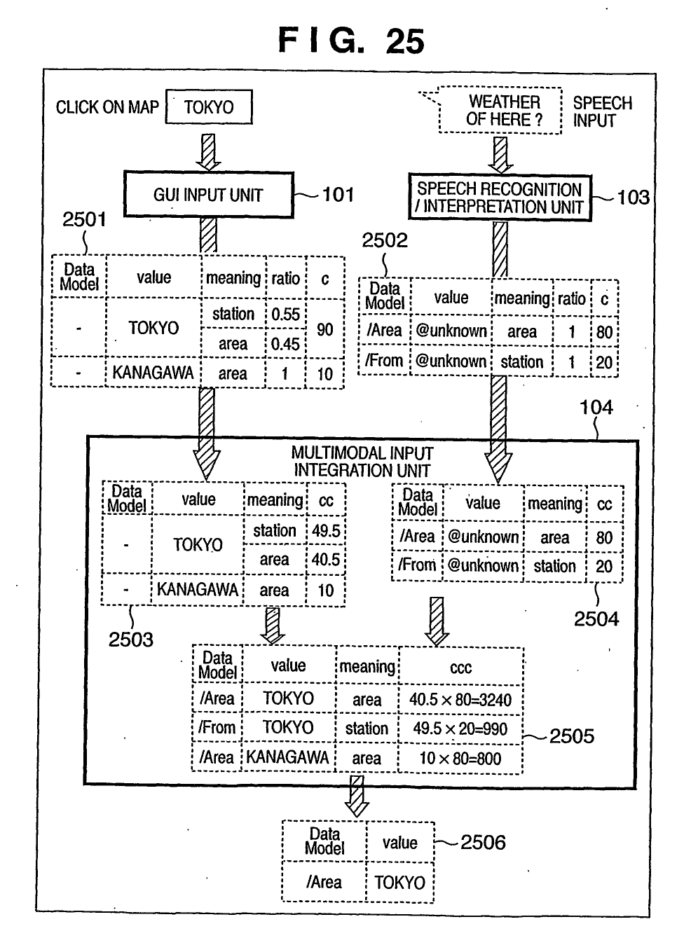

A description example of the confidence level (ratio) of the semantic attribute using the markup language will be explained. In FIG. 24, semantic attributes are designated in the class attribute as in FIG. 22. In this case, colon (:) and the confidence level are appended to each semantic attribute. As shown in FIG. 24, a button having a value “TOKYO” has semantic attributes “station” and “area”, the confidence level of the semantic attribute “station” is “55”, and that of the semantic attribute “area” is “45”. The markup parsing unit 106 (XML parser) separately parses the semantic attribute and confidence level, and outputs the confidence level of the semantic attribute as “ratio” in GUI input information 2501 in FIG. 25. In FIG. 25, the same process as in FIG. 23 is done to output a data bind destination “/Area” and value “TOKYO” (FIG. 25: 2506).

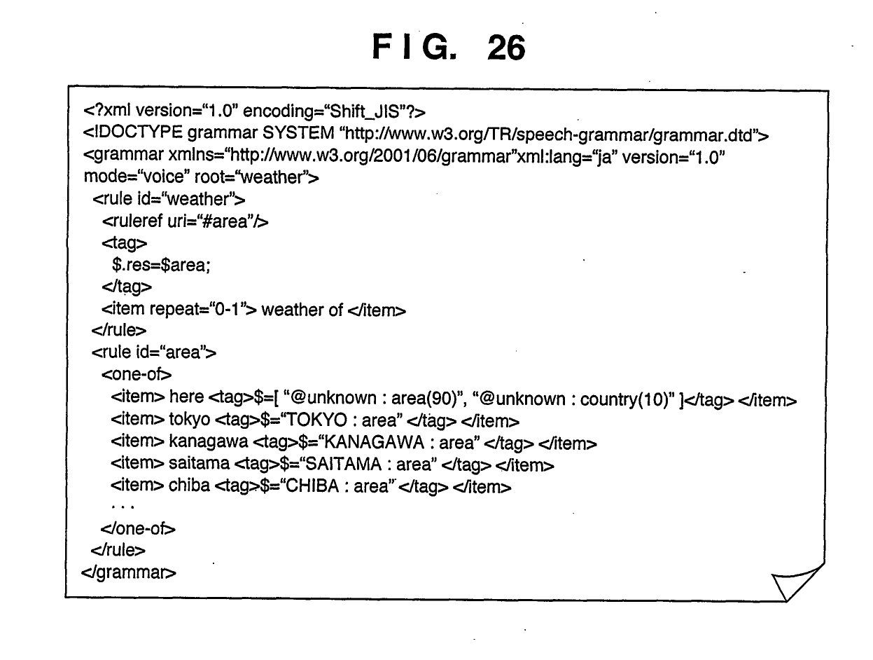

In FIGS. 24 and 25, only one semantic attribute is described in the grammar (rules of grammar) for speech recognition for the sake of simplicity. However, as shown in FIG. 26, a plurality of semantic attributes may be designated by a method using, e.g., List type. As shown in FIG. 26, an input “here” has a value “@unknown”, semantic attributes “area” and “country”, the confidence level “90” of the semantic attribute “area”, and the confidence level “10” of the semantic attribute “country”.

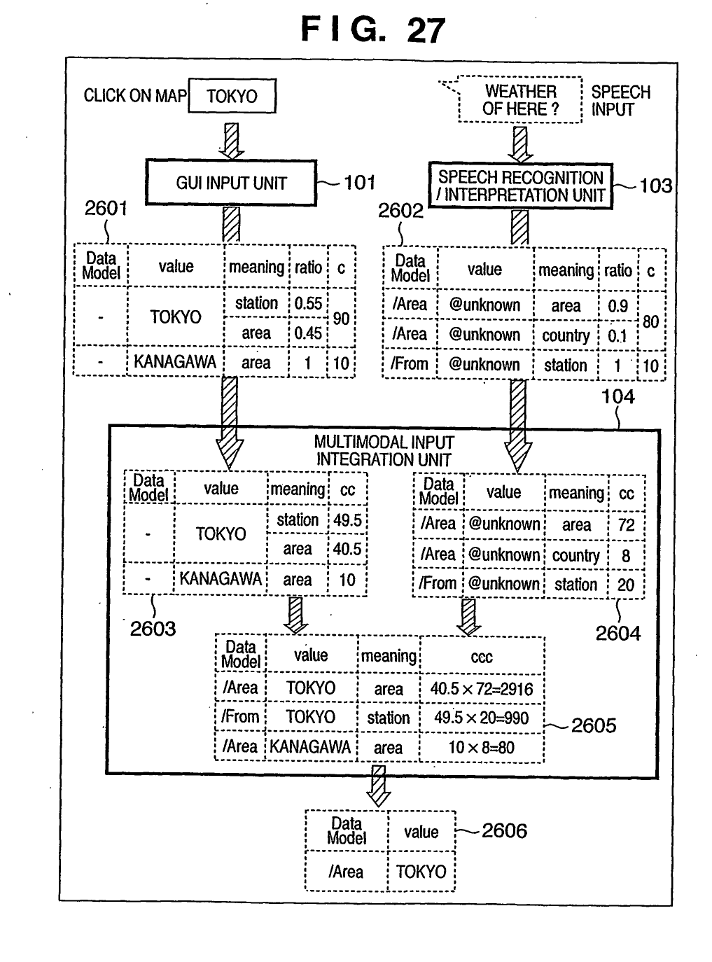

In this case, the integration process is executed, as shown in FIG. 27. The output from the speech recognition/interpretation unit 103 has contents 2602. The multimodal input integration unit 104 calculates confidence levels ccc, as indicated by 2605. As for the semantic attribute “country”, since no input from the GUI input unit 101 has the same semantic attribute, its confidence level is not calculated.

FIGS. 23 and 25 show examples of the integration process based on the confidence levels described in the markup language. Alternatively, the confidence level may be calculated based on the number of matched semantic attributes of input information having a plurality of semantic attributes, and information with the highest confidence level may be selected. For example, if GUI input information having three semantic attributes A, B, and C, GUI input information having three semantic attributes A, D, and E, and speech input information having four semantic attributes A, B, C, and D are to be integrated, the number of common semantic attributes between the GUI input information having semantic attributes A, B, and C and the speech input information having semantic attributes A, B, C, and D is 3. On the other hand, the number of common semantic attributes between the GUI input information having semantic attributes A, D, and E and the speech input information having semantic attributes A, B, C, and D is 2. Hence, the number of common semantic attributes is used as the confidence level, and the GUI input information having semantic attributes A, B, and C, and speech input information A, B, C, and D, which have the high confidence level, are integrated and output.

As described above, according to the second embodiment, an XML document and grammar (rules of grammar) for speech recognition can describe a plurality of semantic attributes, and the intention of the application developer can be reflected on the system. When the system that comprises the multimodal user interface exploits the semantic attribute information, multimodal inputs can be efficiently integrated.

As described above, according to the above embodiments, an XML document and grammar (rules of grammar) for speech recognition can describe a semantic attribute, and the intention of the application developer can be reflected on the system. When the system that comprises the multimodal user interface exploits the semantic attribute information, multimodal inputs can be efficiently integrated.

As described above, according to the present invention, since a description required to process inputs from a plurality of types of input modalities adopts a description of a semantic attribute, integration of inputs that the user or developer intended can be implemented by a simple analysis process.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the function of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

1. An information processing method for recognizing a user's instruction on the basis of a plurality of pieces of input information which are input by a user using a plurality of types of input modalities,
said method having a description including correspondence between input contents and a semantic attribute for each of the plurality of types of input modalities,
said method comprising: an acquisition step of acquiring an input content by parsing each of the plurality of pieces of input information which are input using the plurality of types of input modalities, and acquiring semantic attributes of the acquired input contents from the description; and
an integration step of integrating the input contents acquired in the acquisition step on the basis of the semantic attributes acquired in the acquisition step.

2. The method according to claim 1, wherein one of the plurality of types of input modalities is an instruction of a component via a GUI,
the description includes a description of correspondence between respective components of the GUI and semantic attributes, and
the acquisition step includes a step of detecting an instructed component as an input content, and acquiring a semantic attribute corresponding to the instructed component from the description.

3. The method according to claim 2, wherein the description describes the GUI using a markup language.

4. The method according to claim 1, wherein one of the plurality of types of input modalities is a speech input,
the description includes a description of correspondence between speech inputs and semantic attributes, and
the acquisition step includes a step of applying a speech recognition process to speech information to obtain input speech as an input content, and acquiring a semantic attribute corresponding to the input speech from the description.

5. The method according to claim 4, wherein the description includes a description of a grammar rule for speech recognition, and
the speech recognition step includes a step of applying the speech recognition process to the speech information with reference to the description of the grammar rule.

6. The method according to claim 5, wherein the grammar rule is described using a markup language.

7. The method according to claim 1, wherein the acquisition step includes a step of further acquiring an input time of the input content, and
the integration step includes a step of integrating a plurality of input contents on the basis of the input times of the input contents, and the semantic attributes acquired in the acquisition step.

8. The method according to claim 7, wherein the acquisition step includes a step of acquiring information associated with a value and bind destination of the input content, and
the integration step includes a step of checking based on the information associated with the value and bind destination of the input content if integration is required, outputting, if integration is not required, the input contents intact, integrating the input contents, which require integration, on the basis of the input times and semantic attributes, and outputting the integration result.

9. The method according to claim 8, wherein the integration step includes a step of integrating the input contents which have a input time difference that falls within a predetermined range, and matched semantic attributes, of the input contents that require integration.

10. The method-according to claim 8, wherein the integration step includes a step of outputting, when the input contents or the integration result, which have the input time difference that falls within the predetermined range and the same bind destination, are to be output, the input contents or integration result in the order of input times.

11. The method according to claim 8, wherein the integration step includes a step of selecting, when the input contents or the integration result, which have the input time difference that falls within the predetermined range and the same bind destination, are to be output, the input content or integration result, which is input according to an input modality with higher priority, in accordance with priority of input modalities, which is set in advance, and outputting the selected input content or integration result.

12. The method according to claim 8, wherein the integration step includes a step of integrating input contents in ascending order of input time.

13. The method according to claim 8, wherein the integration step includes a step of inhibiting integration of input contents which include input contents with a different semantic attribute when the input contents are sorted in the order of input times.

14. The method according to claim 1, wherein the description describes a plurality of semantic attributes for one input content, and
the integration step includes a step of determining, when a plurality of types of information are likely to be integrated on the basis of the plurality of semantic attributes, input contents to be integrated on the basis of weights assigned to the respective semantic attributes.

15. The method according to claim 1, wherein the integration step includes a step of determining, when a plurality of input contents are acquired for input information in the acquisition step, input contents to be integrated on the basis of confidence levels of the input contents in parsing.

16. An information processing apparatus for recognizing a user's instruction on the basis of a plurality of pieces of input information which are input by a user using a plurality of types of input modalities, comprising:
a holding unit for holding a description including correspondence between input contents and a semantic attribute for each of the plurality of types of input modalities,
an acquisition unit for acquiring an input content by parsing each of the plurality of pieces of input information which are input using the plurality of types of input modalities, and acquiring semantic attributes of the acquired input contents from the description; and
an integration unit for integrating the input contents acquired by said acquisition unit on the basis of the semantic attributes acquired by said acquisition unit.

17. A description method of describing a GUI, characterized by describing semantic attributes corresponding to respective GUI components using a markup language.

18. A grammar rule for recognizing speech input information input by speech, characterized by describing semantic attributes corresponding to respective speech inputs in the grammar rule.

19. A storage medium storing a control program for making a computer execute an information processing method of claim 1.

20. A control program for making a computer execute an information processing method of claim 1.
